(19) United States
(12) Patent Application Publication
(10) Pub. No.: US 2008/0142150 A1
(43) Pub. Date: Jun. 19, 2008

(54) Method of Obtaining a Preformed Wire that is Intended to be Integrated During the Production of a Tire, and Assembly Comprising a Sheet of Rubber and A Preformed Wire

(75) Inventor: Michel Robert, Cellule (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., Granges-Paccot (CH)

(21) Appl. No.: 11/909,040

(22) PCT Filed: Mar. 21, 2006
(86) PCT No.: PCT/EP2006/060919

§ 371 Date: Sep. 18, 2007

(30) Foreign Application Priority Data
Mar. 21, 2005 (FR) 05/02791

(51) Int. Cl. B29D 30/00

(52) U.S. Cl. 156/117

(57) ABSTRACT

The invention relates to a method of obtaining a preformed wire intended to be incorporated during the manufacture of a tire, comprising a step during which a deformable wire is selected (32), this deformable wire is elastically deformed (34) and this deformable wire is held (36) using holding means which are able to deform or to “disappear” during a shaping step. The invention also relates to an assembly of a sheet of uncured rubber and of a deformable wire.

The present invention relates to a method of obtaining a preformed wire intended to be incorporated during the manufacture of a tire, and to an assembly of a sheet of uncured rubber and of a deformable wire.

Most present-day tires, particularly radial tires, are obtained by employing the following manufacturing method.

During a first step, various constituent parts of the tire are assembled on a cylindrical drum. Among these constituent parts are an airtight internal layer of rubber, a carcass ply, bead wires, and various filler and sidewall protection rubbers or chafers. During a second step, known as the shaping step, the constituent parts assembled during the first step are deformed from the cylindrical shape imparted by the drum to a toric annulus shape similar to that of the future tire. During a third step, crown belting plies and a tread are wrapped around this toric shape to obtain a green tire. Finally, during a fourth step, known as curing, the green tire is placed in a mold and heated to a temperature of the order of 150° C. in the case of a passenger car tire, so as to create the tire tread patterns by molding and ensure the cohesion of the whole by curing.

Certain manufacturers of motor cars, heavy goods vehicles, military vehicles, etc., fit the vehicles with tire pressure measurement systems. To do that, a tire is generally fitted with a pressure sensor and a device for emitting the pressure measurement. The emitting device conventionally comprises an emitter connected to an antenna by a connecting wire. The antenna is generally formed by a conducting wire.

It is known practice for the connecting wire or the antenna wire to be incorporated into the tire during the first step of assembly. Thus, by incorporating it into the mass of the tire, the wire is correctly protected.

The connecting or antenna wire has to be able to withstand the deformation brought about by the shaping step. It is therefore important to use an appropriate wire.

The invention relates to a method of obtaining a preformed wire intended to be incorporated during the manufacture of a tire obtained by implementing a manufacturing method involving:
a step of assembling constituent parts of the tire on a cylindrical drum, during which step a preformed wire in a first configuration known as the integration configuration is incorporated;
a step of shaping the assembled constituent parts, during which step the preformed wire is deformed from its integration configuration to a second configuration known as the shaped configuration; and
a step of curing the shaped constituent parts.

In order for the wire to be able to withstand the shaping operation, it is known practice for it to be incorporated into the tire in the preformed state, for example in a wavy or zigzag shape, so that it is able to deform when subjected to a tensile stress, in the manner of a spring.

During shaping, the wire is stretched in proportion with the extensions imposed and as it naturally tends to oppose the forces it is experiencing it is therefore liable to have an adverse effect on the uniformity of the resulting shaping in the components adjacent to it. Furthermore, after shaping, the stretched wire is not at rest and tends to return to its initial shape. The return forces are proportional to the extension experienced by the wire during the shaping step. These return forces are liable to return the wire to its initial shape, especially during the curing step because the viscosity of the layers of rubber is reduced on account of the high temperature and they do not hold the stretched wire as securely. As it returns to its initial shape, the wire may take with it the components of the tire and in particular may displace the threads of the carcass plies. The structure of the tire thus obtained may therefore exhibit defects which reduce its life or make it less reliable.

It is an object of the invention to remedy these disadvantages by providing a method of obtaining a preformed wire that can be incorporated into a tire without prejudicing the manufacture of the tire.

To this end, a subject of the invention is a method of obtaining a preformed wire intended to be incorporated during the manufacture of a tire obtained by implementing a manufacturing method involving:
a step of assembling constituent parts of the tire on a cylindrical drum, during which step a preformed wire in a first configuration known as the integration configuration is incorporated;
a step of shaping the assembled constituent parts, during which step the preformed wire is deformed from its integration configuration to a second configuration known as the shaped configuration; and
a step of curing the shaped constituent parts; characterized in that the following steps are performed:
a deformable wire is selected;
an integration configuration is determined for the deformable wire on the basis of the amount of shaping that said wire is intended to undergo during the tire shaping step;
this deformable wire is deformed into the integration configuration; and
this deformable wire is held in the integration configuration using holding means which are able to deform or to “disappear” during the shaping and curing steps.

The preformed wire is therefore stressed in its integration configuration. The level of deformation imposed on the preformed wire, its “prestress”, is dependent on the level of shaping, that is to say on the level of extension, that it is liable to experience during the shaping step. When the wire is incorporated into the tire, it is positioned in such a way that the prestress it experiences is relaxed during the shaping step. As a result, the return forces of the preformed wire decrease during shaping and the displacements of the tire components that these return forces may cause during tire manufacture are very greatly reduced.

According to a preferred embodiment, the deformation imposed on the deformable wire into the integration configuration is an elastic deformation.

This embodiment has two advantages. The first is that the elastic deformations are reversible and it is thus possible to have full control over the amount of relaxation of the return forces that is needed in order to obtain a cured tire that is free of the defects associated with the incorporation of the preformed wire. The second advantage is that any plastic deformation is liable to create areas of weakness which may penalize the mechanical strength of the preformed wire while the tire is running along. The quality of the tire obtained is therefore superior to that of tires of the prior art.

By virtue of the holding means, the preformed wire is not at rest but maintains its configuration before being incorporated into the tire. As these holding means are deformable, they do not disrupt the shaping step.

The holding means will be chosen with care to ensure that they are rigid enough to withstand the force generated by the preformed wire and flexible enough to be deformed during the shaping step.

During the tire shaping step, the diameter of the cylindrical drum increases and hence the components of the tire are stretched. As a result, according to one particular embodiment, the elastic deformation imposed on the deformable wire is a compression, so that this wire can relax during the shaping process.

According to one particular embodiment, the deformable wire is more or less at rest in its shaped configuration.

In this case, with the preformed wire intended to be positioned in the tire in such a way that it undergoes a given extension during the shaping step, in its integration configuration, the deformable wire is compressed with a corresponding level of compression.

As a preference, the deformable wire has, at rest, a potential for structural elongation greater than the maximum extension values liable to be experienced when the tire is running along, in the chosen integration region.

The order of magnitude of the maximum extension values experienced when the tire is running along varies widely according to which region of the tire is considered. By way of example, it might be 1 to 10% near the bead wires, in excess of 50% in the sidewalls of the tire, or in excess of 10% in the crown region.

As a preference, the deformable wire has a corrugated, sinusoidal or zigzag shape at rest.

Advantageously, the deformable wire is a metal wire.

According to another particular embodiment, the shaped configuration of the deformable wire is different than the configuration of the deformable wire at rest. For example, the deformable wire may, in its shaped configuration, be compressed by a residual level of compression greater than the maximum extension values liable to be experienced in the chosen integration region when the tire is running along.

In this way, once the tire has been manufactured, the wire incorporated into the tire is not at rest. It can therefore still deform enough to undergo, without breaking, the deformations inherent in normal use of the tire.

When the deformable wire is intended to be positioned in a region of the tire that undergoes a given extension, the deformable wire is then compressed, in its integration configuration, with a level of compression that is a function of the extension associated with the shaping of the tire and of the residual level of compression in the shaped configuration.

According to a preferred embodiment, the deformable wire chosen is one whose configuration at rest is a straight-wire configuration. What that means to say is that the wire chosen comes directly from the various operations associated with its preparation without having undergone any localized plastic deformations that may be liable to create areas of weakness during its subsequent use in the tire.

According to one particular embodiment, in its shaped configuration, the deformable wire is shaped without exhibiting any straight portions. As a result, the preformed wire incorporated into the tire will work not in tension-compression but rather in bending. That appreciably improves its fatigue strength.

One method of obtaining a preformed wire according to the invention may also involve one or more of the following features:
the deformable wire comprises a collection of steel strands;
the steel strands have a brass coating;
the deformable wire has four brass-coated steel strands having individual diameters of 0.12 mm;
the deformable wire is elastically deformed and held in its integration configuration by laying it down directly in its integration configuration onto a sheet of uncured rubber; and
the deformable wire is elastically deformed and held in its integration configuration by laying it down directly in its integration configuration onto a magnetic plate and then transferring the deformable wire onto a sheet of uncured rubber.

It should be noted that, over a single-strand wire of the same diameter, a multi-strand wire has the advantage of being more flexible and far better able to withstand mechanical compressive and bending stresses.

The method according to the invention is such that, in the case of a deformable metal wire, with this metal wire having a given elastic limit Rₚ, in the integration configuration, the stresses experienced at all points in the wire are below this elastic limit Rₚ.

As a preference, when the elastic limit is defined by the conventional elastic limit R_{p0.2}, in the integration configuration, the stresses σ experienced at all points in the wire are such that:

σ<0.8R_{p0.2}.

Observing these stress limits in the step of deforming the metal wire between the rest state and the integration configuration makes it possible to ensure that, during this step, the metal wire will not undergo any plastic deformation liable to create regions of weakness during its subsequent use in the tire.

Another subject of the invention is an assembly of a uncured rubber and of a preformed wire, obtained by implementing a method of obtaining a preformed wire according to the invention.

The sheet of uncured rubber constitutes holding means which are able to deform during the shaping step and are able to “disappear” during the curing step.

The invention will be better understood from reading the description which will follow, given solely by way of example and made with reference to the attached drawings in which:

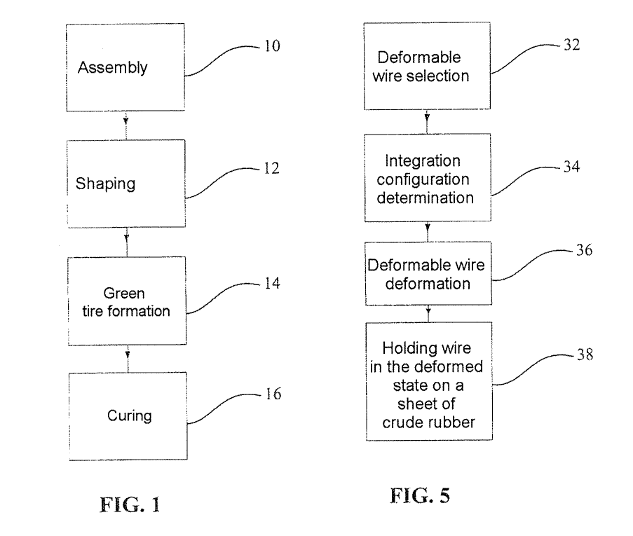

FIG. 1 is a flow diagram depicting the various steps in a tire manufacturing method;

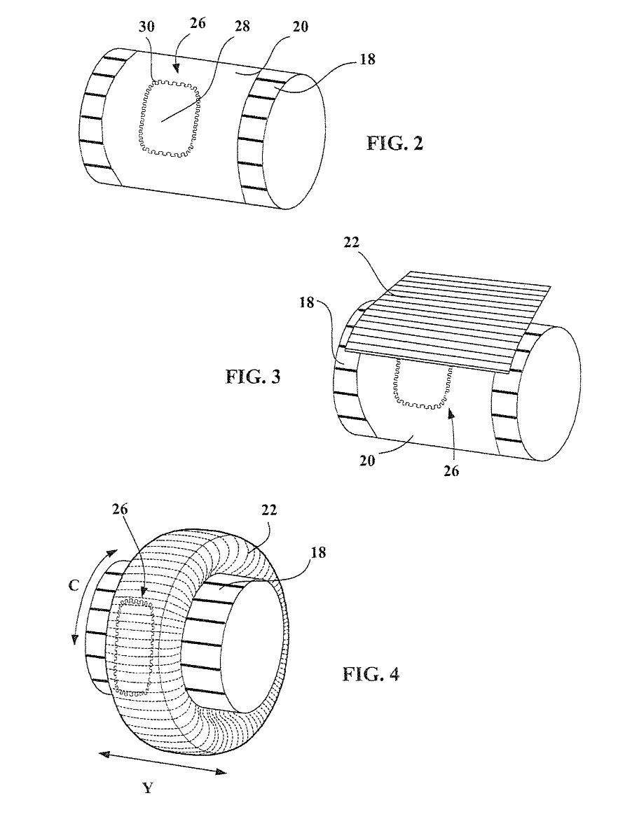

FIG. 2 is a diagram of a tire assembly drum once the assembly according to the invention has been incorporated;

FIG. 3 is a diagram of the assembly drum depicted in FIG. 2 while the carcass ply is being laid;

FIG. 4 is a diagram of the assembly drum depicted in FIGS. 2 and 3 after shaping;

FIG. 5 is a flow diagram depicting the various steps of a method of obtaining a preformed wire according to the invention;

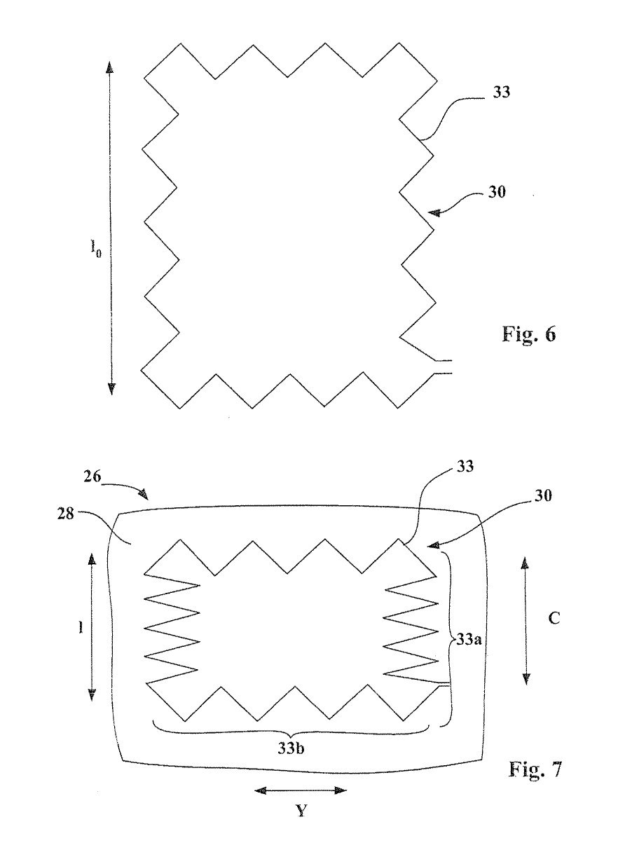

FIG. 6 is a diagram of a first embodiment of a preformed wire according to the invention in its shaped configuration;

FIG. 7 is a diagram of the wire depicted in FIG. 6 in its integration configuration;

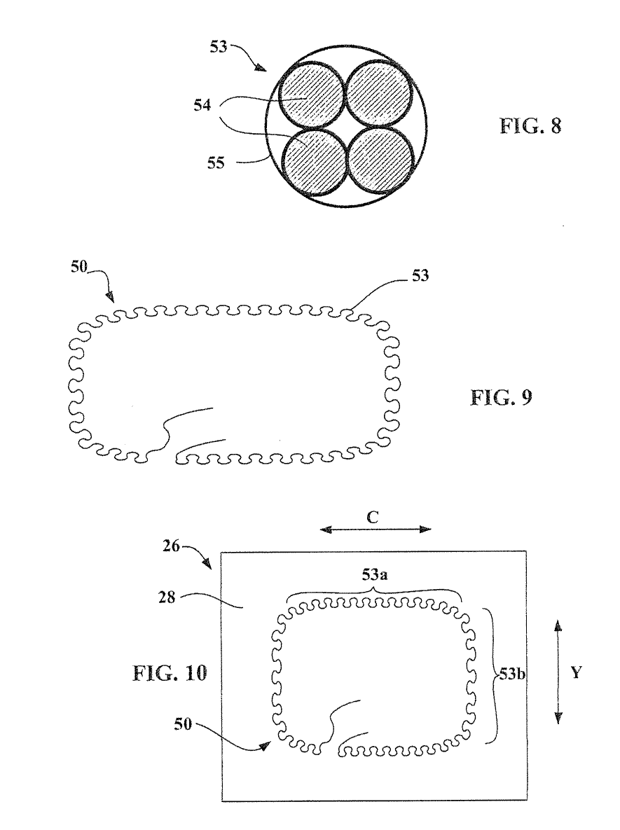

FIG. 8 is a view of a second type of deformable wire viewed in section;

FIG. 9 is a diagram of a second embodiment of a preformed wire according to the invention in its shaped configuration; and

FIG. 10 is a diagram of the wire depicted in FIG. 9 in its integration configuration.

The conventional method for manufacturing a tire, depicted in FIG. 1, comprises a first step 10 of assembly, a second step 12 of shaping, a third step 14 of forming a green tire (that is, an uncured tire) and a fourth step 16 of curing.

During the assembly step 10, shown in FIGS. 2 and 3, various constituent parts including an airtight internal rubber profile 20, a carcass ply 22, bead wires (not depicted) and an assembly 26 consisting of a sheet 28 of uncured rubber and a preformed wire 30 are assembled on a cylindrical drum 18. In FIG. 2, the airtight internal rubber 20 has been laid on, and the assembly 26 has been laid on its surface. FIG. 3 illustrates the laying of the carcass ply 22 around the airtight rubber 20. The assembly 26 is, by way of example, positioned in the tire between the airtight rubber 20 and the carcass ply 22. This assembly 26 is positioned in the middle of the airtight rubber 20. It will therefore lie under the tread of the completed tire.

The preformed wire 30 forms, for example, the antenna of an emission device of a tire pressure measurement system (not depicted). During assembly, the preformed wire 30 is in a first configuration known as the integration configuration, depicted in FIGS. 7 and 10.

During the shaping step 12, the bead wires positioned axially around the two ends of the airtight rubber 20 are brought closer together and the diameter of the part of the drum 18 lying between them increases. At the end of the shaping step 12, the constituent parts of the tire assembled during the assembly step 10 have a toric shape, as depicted in FIG. 4. In particular, it can be seen that the assembly 26 of the sheet 28 of uncured rubber and of the preformed wire 30 has stretched in the circumferential direction C as a result of the increase in diameter of the drum 18. Since the threads of the carcass ply 22 are far more rigid in extension than the uncured compounds, the shaping does not lead to any appreciable extension of the preformed wire in the axial direction Y. The preformed wire 30 is therefore in a second configuration known as the shaped configuration, depicted in FIGS. 6 and 9.

The assembly 26 of the sheet 28 of uncured rubber and of the preformed wire 30 is obtained by implementing, prior to tire manufacture, a method of obtaining a preformed wire according to the invention.

This method, which is depicted in FIG. 5, is now described taking, as a first example of a deformable wire, a metal wire in the form of a zigzag.

This method comprises a first step 32 during which a deformable wire 33, for example the zigzag-shaped wire, is selected. At rest, this wire has a configuration similar to the shaped configuration. Because it is shaped as a zigzag, in the state of rest it has a residual structural elongation vastly greater than 10%. This elongation allows it to withstand the stresses experienced in the crown region when the tire is running along, so that it can be incorporated into this region.

During a second step 34, the integration configuration of the deformable wire 33 is determined. The integration configuration of the deformable wire 33 that is depicted in FIG. 7 is defined by the tire manufacturing method, by the shaped configuration, and by the desired position and orientation of the wire within the tire.

In particular, during the shaping step 12, the deformable wire 33 is stretched mainly in the circumferential direction C. In its integration configuration, the deformable wire 33 therefore comprises regions 33a which are more compressed than other regions 33b. The regions 33a extend in the main directions of stretch C. The regions 33b are intended to be positioned in the axial direction Y.

During the third step 36, the deformable wire 33 is elastically deformed by compressing it from the state of rest to the integration configuration.

The level of compression applied to the deformable wire 33 is substantially equal to the level of shaping, which is a characteristic parameter concerned with the variation in diameter of the drum 18 during the shaping step 12. The level of shaping is dependent on the integration region chosen. Near the bead wires, the variation in diameter is practically zero. The level of shaping is at a maximum under the crown and may be as much as 50%. In order to return the preformed wire 33 to the state of rest in the shaped configuration, the length l₀ of the wire 33a at rest needs to be compressed to l, such that:

$$\frac{{l}_{0} - l}{l} \approx 0.5 ,$$

with 0.5 being the level of shaping or shaping ratio.

During the third step 38, the deformed wire 33 is held in position by a magnetic plate, not depicted. A plate such as this, because of its magnetic properties, holds the deformed wire 33 in position if the wire is endowed with magnetic properties.

Once the deformable wire 33 has been positioned on the magnetic plate in the integration configuration, it is laid onto or bonded to the sheet 28 of uncured rubber during a step 38. The sheet 28 of uncured rubber then constitutes the means for holding the deformable wire 33 which are able to deform during the shaping step 12 and to “disappear” during the curing step 16.

Once the method of obtaining a preformed wire is complete, the terminology employed is no longer deformable wire 33, but preformed wire 30. It is the assembly 26 of the sheet 28 of uncured rubber and of the preformed wire 30 that is intended to be incorporated into a tire during its manufacture.

By virtue of the invention, the prestress forces experienced by the preformed wire are relaxed during shaping and the wire thus has a tendency to comply with the shaping rather than opposing it, and does not disrupt the shaping of the adjacent materials. Furthermore, after the shaping step 12, the preformed wire is in its shaped configuration. Now, in its shaped configuration, the preformed wire 30 is in a configuration close to its rest configuration. As a result, the preformed wire 30 does not disrupt the tire curing step 16.

FIG. 8 shows a sectioned view of a second deformable wire 53 that can be used to be incorporated into a tire. This wire 53 consists of a collection of four brass-coated steel strands 54 of diameter 0.12 mm. This collection is twisted and the circle 55 corresponds to the external envelope of the wire 53. This metal assembly is sufficiently conductive to be used for example as an antenna in a tire or for wire connections.

The rest configuration of this wire 53 is a straight-wire configuration. FIG. 9 shows this wire 53 in its shaped configuration, that is, in the configuration it will have in the new tire, after all the stages in its manufacture. In this configuration, the wire is shaped with a residual elongation that is again vastly greater than 10%, or even 50%, so as to be able to withstand all the stresses experienced when the tire is running along, whatever the region chosen in which to incorporate it. The shaping also has the characteristic of including no straight portions. As a result, all the portions of the wire in the tire will be subjected to bending stresses in respect of which the wire has very good fatigue strength rather than tensile-compressive stresses which prove to be more penalizing. That makes it possible to improve the fatigue life of the preformed wire 50 appreciably.

As before, the wire 53 is greatly compressed in its integration configuration in the direction corresponding to the circumferential direction C in which the parts 53a are to be positioned. The parts 53b intended to be positioned axially along the axis Y are unchanged from one configuration to the other.

The wire 53 is shaped in its integration configuration by deforming it elastically. The bending stresses in the wire at all points observe the conventional elastic limit Rₚ and are preferably such that σ<0.8R_{p0.2}; this conventional elastic limit is described in particular in the standard NF EN 100002-1.

The wire 53 can be deformed in accordance with the integration configuration from the straight-wire state and laid down directly onto a sheet of uncured rubber 28. This rubber is enough to hold it in position. It may be laid down either manually or automatically using an appropriately programmed robot according to a shaping template which guarantees the shaping parameters. It is also possible, as described before, to use a magnetic plate.

FIGS. 9 and 10 show, by way of example, an antenna produced using a deformable wire 53. The use of this assembly according to the method of the invention makes it possible not to disrupt the manufacture of the tire and to obtain excellent fatigue strength when the tire is running along.

1-21. (canceled)

22. A method of obtaining a preformed wire that may be incorporated in a tire during a manufacturing process that includes:
assembling constituent parts of the tire on a cylindrical drum, during which a preformed wire in an integration configuration is incorporated,
shaping the assembled constituent parts, during which the preformed wire is deformed from the integration configuration to a shaped configuration, and
curing the shaped constituent parts,
wherein the method comprises steps of:
selecting a deformable wire;
determining an integration configuration for the deformable wire based on an amount of shaping that the deform able wire is to undergo during shaping of the tire;
deforming the deformable wire into the integration configuration; and
holding the deformable wire in the integration configuration using holding means that is able to deform and disappear during shaping and curing of the tire.

23. A method of obtaining a preformed wire according to claim 22, wherein a deformation imposed on the deformable wire during the deforming step is an elastic deformation.

24. A method of obtaining a preformed wire according to claim 22, wherein a deformation imposed on the deformable wire during the deforming step is a compression.

25. A method of obtaining a preformed wire according to claim 24, wherein the deformable wire is at rest in its shaped configuration.

26. A method of obtaining a preformed wire according to claim 25, wherein the preformed wire is to be positioned in the tire in such a way that the preformed wire is in the integration configuration and undergoes an extension during shaping of the tire, and the deformable wire is compressed with a corresponding level of compression.

27. A method of obtaining a preformed wire according to claim 22, wherein the deformable wire has, at rest, a potential for structural elongation greater than a maximum extension value liable to be experienced in an integration region when the tire is running along.

28. A method of obtaining a preformed wire according to claim 22, wherein the deformable wire has a corrugated, a sinusoidal, or a zigzag shape at rest.

29. A method of obtaining a preformed wire according to claim 22, wherein the deformable wire is a metal wire.

30. A method of obtaining a preformed wire according to claim 24, wherein the shaped configuration of the deformable wire is different than a configuration of the deformable wire at rest.

31. A method of obtaining a preformed wire according to claim 30, wherein, in the shaped configuration, the deformable wire is compressed with a residual level of compression greater than a maximum extension value liable to be experienced in an integration region when the tire is running along.

32. A method of obtaining a preformed wire according to claim 22, wherein, in the shaped configuration, the deformable wire does not exhibit any straight portion.

33. A method of obtaining a preformed wire according to claim 31, wherein, with the deformable wire in the integration configuration and positioned in a region of the tire that undergoes a given extension during shaping of the tire, the deformable wire is compressed with a level of compression that is a function of an extension associated with the shaping of the tire and of a residual level of compression in the shaped configuration.

34. A method of obtaining a preformed wire according to claim 22, wherein the deformable wire at rest has a straight-wire configuration.

35. A method of obtaining a preformed wire according to claim 34, wherein the deformable wire includes steel strands.

36. A method of obtaining a preformed wire according to claim 35, wherein the steel strands have a brass coating.

37. A method of obtaining a preformed wire according to claim 36, wherein the deformable wire has four brass-coated steel strands each having an individual diameter of about 0.12 mm.

38. A method of obtaining a preformed wire according to claim 22, wherein the deformable wire has an elastic limit, Rₚ, in the integration configuration, such that stresses experienced at all points in the deformable wire are below the elastic limit, Rₚ.

39. A method of obtaining a preformed wire according to claim 22, wherein the deformable wire has an elastic limit, R_{p0.2}, in the integration configuration, such that stresses, σ, experienced at all points in the deformable wire are such that:
σ<0.8R_{p0.2}.

40. A method of obtaining a preformed wire according to claim 22, wherein the steps of deforming the deformable wire and holding the deformable wire in the integration configuration are performed by laying the deformable wire in its integration configuration directly onto a sheet of uncured rubber.

41. A method of obtaining a preformed wire according to claim 22, wherein the steps of deforming the deformable wire and holding the deformable wire in the integration configuration are performed by laying the deformable wire in its integration configuration directly onto a magnetic plate and transferring the preformed wire onto a sheet of uncured rubber.

42. An assembly of a sheet of uncured rubber and a preformed wire, wherein the assembly is obtained by implementing a method according claim 40.

43. An assembly of a sheet of uncured rubber and a preformed wire, wherein the assembly is obtained by implementing a method according claim 41.
